(19) United States
(12) Patent Application Publication
(10) Pub. No.: US 2021/0397364 A1
(43) Pub. Date: Dec. 23, 2021

(54) STORAGE DEVICE AND OPERATING METHOD THEREOF

(71) Applicant: SK hynix Inc., Gyeonggi-do (KR)

(72) Inventors: Young Ick CHO, Gyeonggi-do (KR); Jea Young ZHANG, Gyeonggi-do (KR)

(21) Appl. No.: 17/159,976

(22) Filed: Jan. 27, 2021

(30) Foreign Application Priority Data
Jun. 17, 2020 (KR) 10-2020-0073643

(51) Int. Cl. G06F 3/06

(52) U.S. Cl. CPC G06F 3/0655; G06F 3/0604; G06F 3/0679

(57) ABSTRACT

A storage device includes: a nonvolatile memory including map data; and a controller configured to read map data to be uploaded among the map data, to divide the map data to be uploaded into a plurality of map units, to sequentially encode the plurality of map units, and to transmit the encoded map units to a host. The controller encodes a next map unit while a map unit encoded in a previous step is transmitted to the host.

### CROSS-REFERENCE TO RELATED APPLICATION

The present application claims priority under 35 U.S.C. § 119(a) to Korean application number 10-2020-0073643, filed on Jun. 17, 2020, in the Korean Intellectual Property Office, which is incorporated herein by reference in its entirety.

### BACKGROUND

### 1. Technical Field

Various embodiments generally relate to an electronic device, and more particularly, to a storage device and an operating method thereof.

### 2. Related Art

Recently, a paradigm for a computer environment has been changed to ubiquitous computing which enables a computer system to be used anytime and anywhere. Therefore, the use of portable electronic devices such as cellular phones, digital cameras, and notebook computers is rapidly increasing. Such portable electronic devices generally use a data storage device having a memory component. The data storage device is used to store data used in the associated portable electronic device.

The data storage device using the memory component is advantageous in that stability and durability are superior due to the absence of a mechanical driving unit, information access speed is very fast, and power consumption is low. Examples of data storage devices having such advantages include a universal serial bus (USB) memory device, a memory card having various interfaces, a universal flash storage (UFS) device, and a solid-state drive.

### SUMMARY

Various embodiments are directed to providing a storage device capable of shortening a map data uploading time and an operating method thereof.

In an embodiment, a storage device includes: a nonvolatile memory including map data; and a controller configured to read map data to be uploaded among the map data, to divide the map data to be uploaded into a plurality of map units, to sequentially encode the plurality of map units, and to transmit the encoded map units to a host. The controller encodes a next map unit while a map unit encoded in a previous operation is transmitted to the host.

In an embodiment, an operating method of a storage device includes: reading map data to be uploaded among the map data from a nonvolatile memory; dividing the map data to be uploaded into a plurality of map units; and sequentially encoding the plurality of map units and transmitting the encoded map units to a host. A next map unit is encoded while a map unit encoded in a previous operation is transmitted to the host.

In an embodiment, a controller includes: a first core configured to serve as an interface with a host; a memory including a first buffer and a second buffer larger than the first buffer; and a second core configured to read map data to be uploaded among map data stored in a nonvolatile memory and to store the read map data to be uploaded in the first buffer. The first core divides the map data to be uploaded stored in the first buffer into a plurality of map units, sequentially encodes the plurality of map units, and stores the encoded map units in the second buffer. The first core encodes a next map unit while the encoded map units stored in the second buffer are transmitted to the host.

In an embodiment, a method of operating a controller includes: encoding a first map unit; transmitting the encoded first map unit to a host; and encoding a second map unit while transmitting the encoded first map unit to the host.

In accordance with embodiments, transmission of a previously encoded map unit and encoding of a next map unit are simultaneously performed, so that the time it takes for encoding map data to be uploaded can be shortened. As a consequence, the time it takes for uploading the map data to the host can also be shortened, and as the upload time of the map data is shortened, a processing delay of a read command can be reduced to improve read performance.

### BRIEF DESCRIPTION OF THE DRAWINGS

FIG. 1 is a diagram illustrating a storage device in accordance with an embodiment.

FIG. 2 is a diagram illustrating a nonvolatile memory, such as that of FIG. 1.

FIG. 3 is a diagram illustrating an address mapping table.

FIG. 4 is a diagram illustrating a memory, such as that of FIG. 1.

FIG. 5 is a diagram illustrating an operation of uploading map data to a host in accordance with an embodiment.

FIG. 6 is a diagram illustrating that encoding of map units and transmission of encoded map units are simultaneously performed in accordance with an embodiment.

FIG. 7 is a flowchart illustrating an operating method of a storage device in accordance with an embodiment.

FIG. 8 is a diagram illustrating a data processing system including a solid state drive (SSD) in accordance with an embodiment.

FIG. 9 is a diagram illustrating a controller, such as that illustrated in FIG. 8.

FIG. 10 is a diagram illustrating a data processing system including a data storage apparatus in accordance with an embodiment.

FIG. 11 is a diagram illustrating a data processing system including a data storage apparatus in accordance with an embodiment.

FIG. 12 is a diagram illustrating a network system including a data storage apparatus in accordance with an embodiment.

FIG. 13 is a diagram illustrating a nonvolatile memory device included in a data storage apparatus in accordance with an embodiment.

### DETAILED DESCRIPTION

Hereinafter, various embodiments are described with reference to the accompanying drawings. Throughout the specification, reference to “an embodiment,” “another embodiment” or the like is not necessarily to only one embodiment, and different references to any such phrase are not necessarily to the same embodiment(s). Also, the term “embodiments” when used herein does not necessarily refer to all embodiments.

FIG. 1 is a diagram illustrating a configuration of a storage device 10 in accordance with an embodiment.

Referring to FIG. 1, the storage device 10 may store data that is accessed by a host (not illustrated) such as a cellular phone, an MP3 player, a laptop computer, a desktop computer, a game machine, a television, and/or an in-vehicle infotainment system. The storage device 10 may also be called a memory system.

The storage device 10 may be implemented with any of various types of storage devices according to an interface protocol connected to the host. For example, the storage device 10 may be configured as a multimedia card in the form of a solid state drive (SSD), an MMC, an eMMC, an RS-MMC, or a micro-MMC, a secure digital card in the form of an SD, a mini-SD, or a micro-SD, a universal serial bus (USB) storage device, a universal flash storage (UFS) device, a storage device in the form of a personal computer memory card international association (PCMCIA) card, a storage device in the form of a peripheral component interconnection (PCI) card, a storage device in the form of a PCI express (PCI-E) card, a compact flash (CF) card, a smart media card, and/or a memory stick.

The storage device 10 may be fabricated as any of various types of packages. For example, the storage device 10 may be fabricated as a package on package (POP), a system in package (SIP), a system on chip (SOC), a multi-chip package (MCP), a chip on board (COB), a wafer-level fabricated package (WFP), and/or a wafer-level stack package (WSP).

The storage device 10 may include a nonvolatile memory 100 and a controller 200.

The nonvolatile memory 100 may operate as a data storage medium of the storage device 10. The nonvolatile memory 100 may be configured as any of various types of nonvolatile memories, such as a NAND flash memory apparatus, a NOR flash memory apparatus, a ferroelectric random access memory (FRAM) using a ferroelectric capacitor, a magnetic random access memory (MRAM) using a tunneling magneto-resistive (TMR) film, a phase change random access memory (PRAM) using chalcogenide alloys, and/or a resistive random access memory (ReRAM) using a transition metal oxide, according to memory cells.

For clarity, FIG. 1 illustrates the nonvolatile memory 100 as one block. However, the nonvolatile memory 100 may include a plurality of memory chips (or dies). The present invention may be equally applied to the storage device 10 including the nonvolatile memory 100 composed of the plurality of memory chips.

The nonvolatile memory 100 may include a memory cell array (not illustrated) having a plurality of memory cells arranged in respective intersection regions of a plurality of bit lines (not illustrated) and a plurality of word lines (not illustrated). The memory cell array may include a plurality of memory blocks and each of the plurality of memory blocks may include a plurality of pages.

For example, each memory cell of the memory cell array may be a single level cell (SLC) that stores one bit, a multi-level cell (MLC) capable of storing two bits of data, a triple level cell (TLC) capable of storing three bits of data, or a quad level cell (QLC) capable of storing four bits of data. The memory cell array may have a mix of different types of memory cells among the single level cell, the multi-level cell, the triple level cell, and the quad level cell. The memory cell array may include memory cells having a two-dimensional horizontal structure or memory cells having a three-dimensional vertical structure.

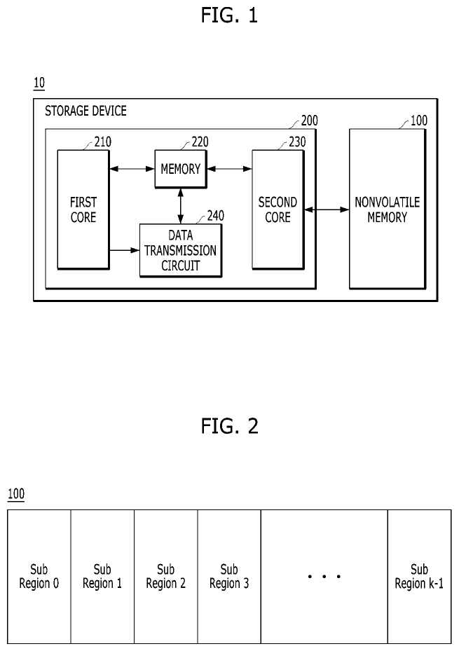

FIG. 2 is a diagram illustrating the nonvolatile memory 100 of FIG. 1.

Referring to FIG. 2, the nonvolatile memory 100 may include a plurality of subregions, i.e., Sub Region 0 to Sub Region k−1 (k is a natural number equal to or more than 2). Each of the subregions may be substantially the same size or different regions may have different sizes. Each of the plurality of subregions may include a plurality of memory blocks, each of which may include a plurality of pages; however, the present disclosure is not particularly limited thereto. The subregion may be called a sub-memory region.

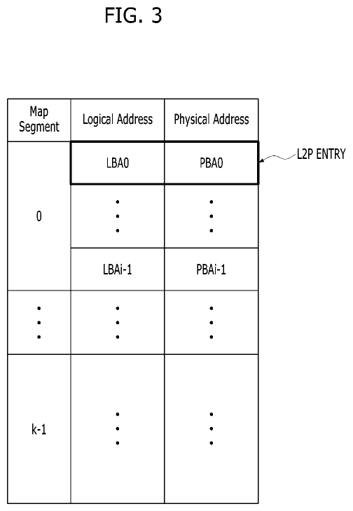

FIG. 3 is a diagram illustrating an address mapping table. The address mapping table illustrated in FIG. 3 may be included in the nonvolatile memory 100.

Referring to FIG. 3, the address mapping table may include a plurality of map segments, each of which may include i logical addresses and i physical addresses mapped to the i logical addresses, respectively (i is a natural number equal to or more than 2). That is, each of the plurality of map segments may include i logical address to physical address (L2P) entries. Each L2P entry may include one logical address and one physical address mapped to each other.

The logical addresses included in each of the plurality of map segments may be sorted and arranged in the address mapping table in a particular order, e.g., an ascending or descending order; however, the present disclosure is not particularly limited thereto. A physical address mapped to each logical address may be updated to a physical address in which data related to the corresponding logical address is newly stored. Furthermore, mapping between the logical addresses and the physical addresses may be unmapped according to an unmap request from the host.

As illustrated in FIG. 3, a plurality of map segments 0 to k−1 (k is a natural number equal to or more than 2) may correspond to the plurality of subregions Sub Region 0 to Sub Region k−1 illustrated in FIG. 2, respectively. For example, the map segment ‘0’ may correspond to Sub Region 0. Furthermore, the number of map segments and the number of subregions may be substantially the same.

Furthermore, the map update operation may be performed on a map segment basis. The map update operation may indicate a mapping information change operation. The mapping information change may include changing a physical address mapped to a logical address to a physical address corresponding to a location where data related to the logical address is newly stored.

For example, when a logical address of which mapping information is to be updated (or changed) is ‘LBA0’, all logical addresses LBA0 to LBAi−1 included in the map segment ‘0’ including ‘LBA0’ are read during the map update operation and are stored in a map update buffer (not illustrated) of a memory 220, and then mapping information of ‘LBA0’, that is, a physical address PBA may be changed.

Referring back to FIG. 1, the controller 200 may control overall operation of the storage device 10. The controller 200 may process requests received from the host. The controller 200 may generate control signals for controlling the operation of the nonvolatile memory 100 in response to the requests received from the host, and provide the generated control signals to the nonvolatile memory 100. The controller 200 may include a first core 210, the memory 220, a second core 230, and a data transmission circuit 240.

The first core 210 may serve as an interface between the host and the storage device 10 in accordance with the protocol of the host. Therefore, the first core 210 may be called a protocol core. For example, the first core 210 may communicate with the host through any of various protocols, such as universal serial bus (USB), universal flash storage (UFS), multi-media card (MMC), parallel advanced technology attachment (PATA), serial advanced technology attachment (SATA), small computer system interface (SCSI), serial attached SCSI (SAS), peripheral component interconnection (PCI), and/or PCI express (PCI-e) protocols.

The first core 210 may include a micro control unit (MCU) and a central processing unit (CPU).

The first core 210 may receive commands transmitted from the host and provide the received commands to the second core 230. For example, the first core 210 may queue the commands received from the host in a command queue (not illustrated) of the memory 220 and provide the second core 230 with information indicating that the commands are queued; however, the present disclosure is not particularly limited thereto.

The first core 210 may store data (for example, write data) received from the host in a write buffer (not illustrated) of the memory 220. Furthermore, the first core 210 may transmit data (for example, read data) stored in a read buffer (not illustrated) of the memory 220 to the host.

The first core 210 may divide map data to be uploaded, which is stored in a map loading buffer 222 of the memory 220, into a plurality of map units. The first core 210 may sequentially encode the plurality of divided map units from a first map unit to a last map unit, and store the encoded map units in a map uploading buffer 223.

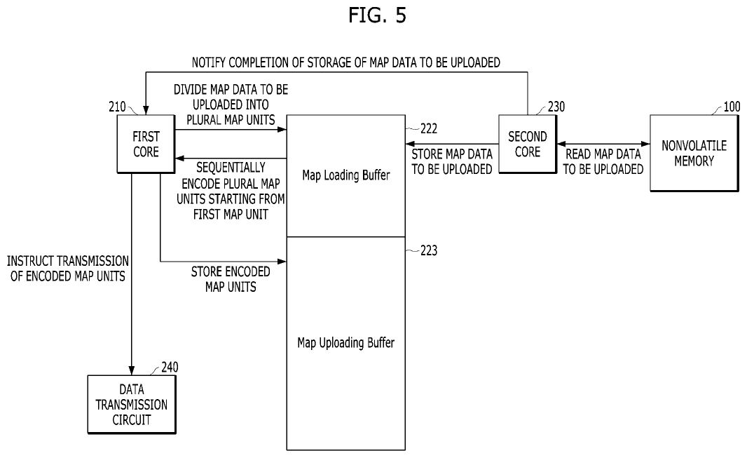

The first core 210 may transmit a control signal to the data transmission circuit 240 to transmit the encoded map units stored in the map uploading buffer 223 to the host. For example, the first core 210 may transmit, to the data transmission circuit 240, a control signal for transmitting the encoded first map unit stored in the map uploading buffer 223 to the host, and simultaneously read a next map unit, that is, a second map unit, from the map loading buffer 222 and encode the second map unit. That is, the controller 200 of the storage device 10 in accordance with an embodiment may perform, at the same time or during the same time period, an operation of transmitting a previously encoded map unit to the host and an operation of encoding a next map unit. This is described below in more detail with reference to FIG. 5.

The memory 220 may be configured as a random-access memory such as a static random-access memory (SRAM) or a dynamic random-access memory (DRAM); however, the present disclosure is not particularly limited thereto. Although FIG. 1 illustrates that the memory 220 is included in the controller 200, in another embodiment, the memory 220 may be disposed outside, and operably coupled to, the controller 200.

The memory 220 may be physically and electrically connected to the first core 210 and the second core 230. The memory 220 may store firmware that is executed by the second core 230. Furthermore, the memory 220 may store data for executing the firmware, for example, meta data. That is, the memory 220 may operate as a working memory of the second core 230.

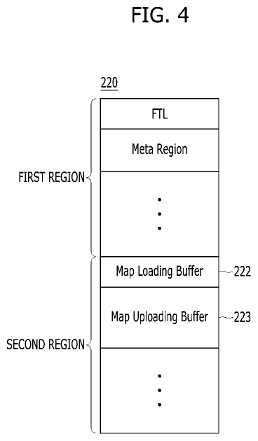

Furthermore, the memory 220 may be configured to include buffers for temporarily storing write data to be transmitted from the host to the nonvolatile memory 100 and read data to be transmitted from the nonvolatile memory 100 to the host, that is, the write buffer and the read buffer. That is, the memory 220 may operate as a buffer memory. The internal configuration of the memory 220 is described below in detail with reference to FIG. 4.

The second core 230 may control overall operation of the storage device 10 by executing firmware or software loaded in the memory 220. The second core 230 may decrypt and execute a code type instruction or algorithm such as firmware or software. Therefore, the second core 230 may also be called a flash translation layer (FTL) core. The second core 230 may include a micro control unit (MCU) and a central processing unit (CPU).

The second core 230 may generate control signals for controlling the operation of the nonvolatile memory 100 on the basis of a command provided from the first core 210, and provide the generated control signals to the nonvolatile memory 100. The control signals may include a command, an address, an operation control signal and the like for controlling the nonvolatile memory 100. The second core 230 may provide the nonvolatile memory 100 with the write data temporarily stored in the memory 220, or store the read data received from the nonvolatile memory 100 in the memory 220.

The data transmission circuit 240 may operate according to the control signal provided from the first core 210. For example, the data transmission circuit 240 may store the write data received from the host in the write buffer of the memory 220 according to the control signal received from the first core 210. Furthermore, the data transmission circuit 240 may read the read data stored in the read buffer of the memory 220 and transmit the read data to the host according to the control signal received from the first core 210. Furthermore, the data transmission circuit 240 may transmit map data (for example, the encoded map unit) stored in the memory 220 to the host according to the control signal received from the first core 210.

FIG. 4 is a diagram illustrating the memory 220 of FIG. 1.

Referring to FIG. 4, the memory 220 in accordance with an embodiment may be divided into a first region and a second region; however, the present disclosure is not particularly limited thereto. For example, the first region of the memory 220 may store software (or firmware) interpreted and executed by the second core 230 and meta data and the like used when the second core 230 performs computation and processing operations. Furthermore, the first region of the memory 220 may store commands received from the host.

For example, software stored in the first region of the memory 220 may be the flash translation layer (FTL). The flash translation layer (FTL) may be executed by the second core 230, and the second core 230 may execute the flash translation layer (FTL) to control the unique operation of the nonvolatile memory 100, and provide the host with device compatibility. Through the execution of the flash translation layer (FTL), the host may recognize and use the storage device 10 as a general storage device such as a hard disk.

The flash translation layer (FTL) may be stored in a system region (not illustrated) of the nonvolatile memory 100, and when the storage device 10 is powered on, the flash translation layer (FTL) may be read from the system region of the nonvolatile memory 100 and loaded in the first region of the memory 220. Furthermore, the flash translation layer (FTL) loaded in the first region of the memory 220 may also be loaded in a dedicated memory (not illustrated) of the second core 230 separately provided within or part of the second core 230.

The flash translation layer (FTL) may include modules for performing various functions. For example, the flash translation layer (FTL) may include a read module, a write module, a garbage collection module, a wear-leveling module, a bad block management module, a map module, and the like; however, the present disclosure is not particularly limited thereto. For example, each of the modules included in the flash translation layer (FTL) may be composed of a set of source codes for performing a specific operation (or function).

The map module may control the nonvolatile memory 100 and the memory 220 to perform operations related to the map data. The operations related to the map data may include a map update operation, a map caching operation, and a map upload operation; however, the present disclosure is not particularly limited thereto.

The map update operation may include changing the physical address of the L2P entry stored in the address mapping table (see FIG. 3) to a physical address indicating a location where data related to a corresponding logical address is newly stored and storing the L2P entry with the changed physical address in the nonvolatile memory 100.

The map caching operation may include reading a mag segment, which includes an L2P entry corresponding to a logical address received with a read command from the host, from the nonvolatile memory 100 and storing the mag segment in a map caching buffer (not illustrated) of the memory 220. The map caching operation may be performed on a logical address frequently requested to be read and a logical address most recently requested to be read.

The map upload operation may include reading map data to be uploaded from the nonvolatile memory 100 and transmitting the map data to the host. The operation of reading the map data to be uploaded from the nonvolatile memory 100 may be performed on a map segment basis and transmitting the map data to be uploaded to the host may be performed on a map unit basis. The map upload operation may further include encoding the map data to be uploaded. The operation of encoding the map data to be uploaded may be performed on a map unit basis.

For example, the second core 230 may read the map data to be uploaded from the nonvolatile memory 100 in response to a map read command received from the host, store the map data to be uploaded in the map loading buffer 222 of the memory 220, and transmit, to the first core 210, information indicating that the loading of the map data has been completed.

The first core 210 may divide the map data to be uploaded, which is stored in the map loading buffer 222, into a plurality of map units, sequentially encode the plurality of map units, store the encoded map units in the map uploading buffer 223, and provide the data transmission circuit 240 with a control signal for transmitting the encoded map units. For example, the first core 210 may add corresponding meta information and cyclical redundancy check (CRC) value to each of the plurality of map units, and randomize and encode the map units; however, the encoding method of the map units is not particularly limited thereto.

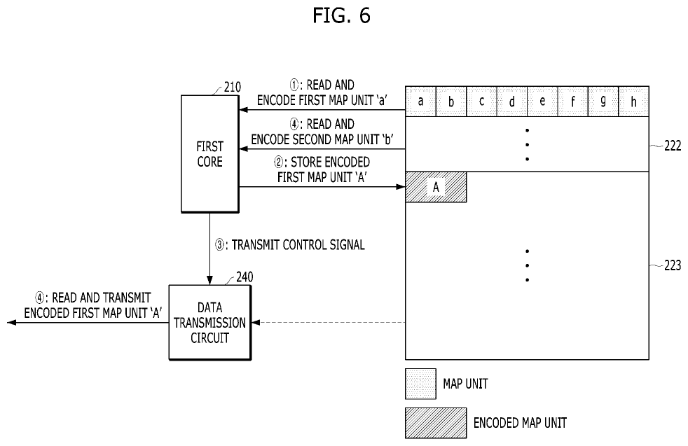

The first region of the memory 220 may include a meta region where meta data for driving various modules included in the flash translation layer (FTL) is stored. The map loading buffer 222 and the map uploading buffer 223 within the second region of the memory 220 are described in more detail with reference to FIGS. 5 and 6.

FIG. 5 is a diagram illustrating an operation of uploading map data to the host in accordance with an embodiment. Such operation is performed in response to a map read command received from the host. The map read command may include information on a subregion corresponding to map data to be uploaded, and the second core 230 may determine map data to be uploaded on the basis of the information included in the map read command.

Referring to FIG. 5, the second core 230 may read map data to be uploaded from the nonvolatile memory 100 (denoted “READ MAP DATA TO BE UPLOADED” in the figure) and store the map data to be uploaded in the map loading buffer 222 of the memory 220. Furthermore, the second core 230 may provide the first core 210 with information indicating that the map data to be uploaded has been stored in the map loading buffer 222 (“NOTIFY COMPLETION OF STORAGE OF MAP DATA TO BE UPLOADED” in the figure).

The first core 210 may divide the map data to be uploaded, which is stored in the map loading buffer 222, into a plurality of map units (“DIVIDE MAP DATA TO BE UPLOADED INTO PLURAL MAP UNITS” in the figure), and sequentially read and encode a first map unit to a last map unit (“SEQUENTIALLY ENCODE PLURAL MAP UNITS STARTING FROM FIRST MAP UNIT” in the figure). Furthermore, the first core 210 may sequentially store the encoded first map unit to the encoded last map unit in the map uploading buffer 223 (“STORE ENCODED MAP UNITS” in the figure). Furthermore, the first core 210 may transmit a control signal to the data transmission circuit 240 (“INSTRUCT TRANSMISSION OF ENCODED MAP UNITS” in the figure) such that the encoded first map unit to the encoded last map unit are sequentially transmitted whenever the storage of each of the encoded map units into the map uploading buffer 223 is completed.

FIG. 6 is a diagram illustrating that encoding of map units and transmission of encoded map units are simultaneously performed in accordance with an embodiment. Unencoded map units are denoted by ‘a to h’ and an encoded map unit is denoted by ‘A’.

Referring to FIG. 6, the first core 210 may read and encode the first map unit ‘a’ from the map loading buffer 222 (\textcircled{1}). Then, the first core 210 may store the encoded first map unit ‘A’ in the map uploading buffer 223 (\textcircled{2}). Then, the first core 210 may transmit a control signal to the data transmission circuit 240 (\textcircled{3}). The control signal may be for reading the encoded first map unit ‘A’ from the map uploading buffer 223 and transmitting the read first map unit ‘A’ to the host.

The data transmission circuit 240 may read the encoded first map unit ‘A’ from the map uploading buffer 223 according to the control signal received from the first core 210, and transmit the read first map unit ‘A’ to the host (\textcircled{4}). Simultaneously, the first core 210 may read and encode the second map unit ‘b’ from the map loading buffer 222 (\textcircled{4}). The operations ‘\textcircled{1} to \textcircled{4}’ may be repeatedly performed until encoding and transmission of the last map unit of the plurality of map units stored in the map loading buffer 222 is completed.

Among the plurality of map units, transmission of a previous encoded map unit to the host and encoding of a current map unit are simultaneously performed, so that the time it takes for encoding map data to be uploaded can be shortened. As a consequence, the time it takes for uploading the encoded map data to the host can also be shortened, and as the upload time of the map data is shortened, a processing delay of a read command can be reduced to improve read performance.

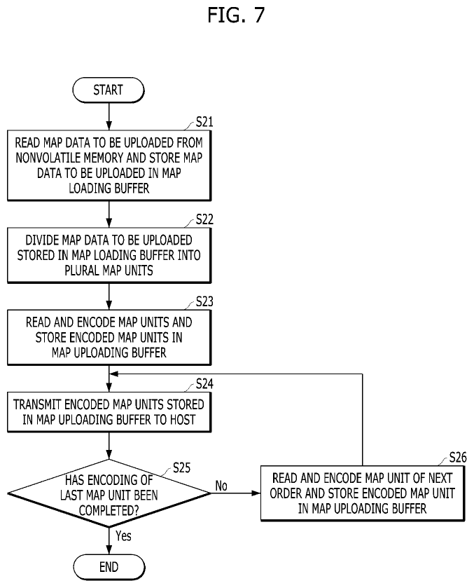

FIG. 7 is a flowchart illustrating an operating method of the storage device in accordance with an embodiment. The operating method of the storage device is described primarily with reference to FIG. 7, with secondary reference to other figures. Although not illustrated in FIG. 7, it is assumed that a map read command has been received from the host.

In operation S21, the second core 230 of the controller 200 may read map data to be uploaded from the nonvolatile memory 100 and store the map data to be uploaded in the map loading buffer 222 of the memory 220. Furthermore, the second core 230 may provide the first core 210 with information indicating that the storage of the map data to be uploaded has been completed.

In operation S22, the first core 210 of the controller 200 may divide the map data to be uploaded, which is stored in the map loading buffer 222, into a plurality of map units.

In operation S23, the first core 210 may sequentially read and encode the plurality of map units from the map loading buffer 222 starting from a first map unit, and store the encoded map units in the map uploading buffer 223 of the memory 220.

In operation S24, the first core 210 may provide the data transmission circuit 240 with a control signal (for example, a control signal for transmitting the encoded map units to the host), and the data transmission circuit 240 may read the encoded map units from the map uploading buffer 223 according to the control signal and transmit the read map units to the host.

In operation S25, the first core 210 may determine whether encoding of a last map unit has been completed. When the encoding of the last map unit has been completed, the process may end. However, when the encoding of the last map unit has not been completed, the process may proceed to operation S26.

In operation S26, the first core 210 may read and encode a next map unit from the map loading buffer 222, and store the encoded next map unit in the map uploading buffer 223.

In such a case, as illustrated in FIG. 6, operation S24, in which the data transmission circuit 240 reads the encoded map units from the map uploading buffer 223 and transmits the read map units to the host and operation S26, in which the first core 210 reads and encodes the next map unit from the map loading buffer 222, may be simultaneously (or overlappingly) performed.

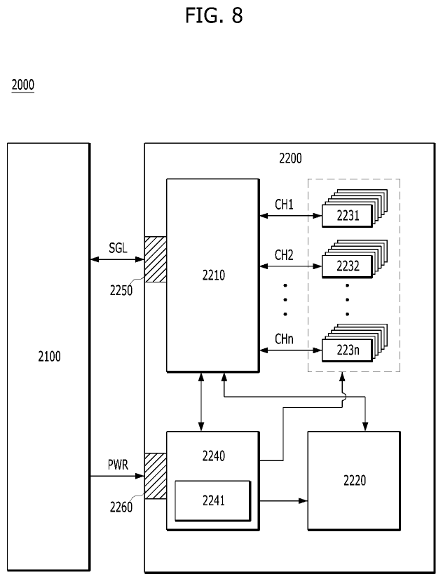

FIG. 8 illustrates a data processing system including a solid state drive (SSD) in accordance with an embodiment. Referring to FIG. 8, a data processing system 2000 may include a host apparatus 2100 and an SSD 2200.

The SSD 2200 may include a controller 2210, a buffer memory device 2220, nonvolatile memory devices 2231 to 223n, a power supply 2240, a signal connector 2250, and a power connector 2260.

The controller 2210 may control overall operation of the SSD 2220.

The buffer memory device 2220 may temporarily store data to be stored in the nonvolatile memory devices 2231 to 223n. The buffer memory device 2220 may temporarily store data read from the nonvolatile memory devices 2231 to 223n. The data temporarily stored in the buffer memory device 2220 may be transmitted to the host apparatus 2100 or the nonvolatile memory devices 2231 to 223n according to control of the controller 2210.

The nonvolatile memory devices 2231 to 223n may be used as a storage medium of the SSD 2200. The nonvolatile memory devices 2231 to 223n may be coupled to the controller 2210 through a plurality of channels CH1 to CHn, respectively. In another embodiment, more than one nonvolatile memory device may be coupled to the same channel. The nonvolatile memory devices coupled to the same channel may be coupled to the same signal bus and the same data bus.

The power supply 2240 may provide power PWR input through the power connector 2260 to the inside of the SSD 2200. The power supply 2240 may include an auxiliary power supply 2241. The auxiliary power supply 2241 may supply the power so that the SSD 2200 is properly terminated even when sudden power-off occurs. The auxiliary power supply 2241 may include large capacity capacitors capable of charging the power PWR.

The controller 2210 may exchange a signal SGL with the host apparatus 2100 through the signal connector 2250. The signal SGL may include a command, an address, data, and the like. The signal connector 2250 may be configured of various any of types of connectors according to an interfacing method between the host apparatus 2100 and the SSD 2200.

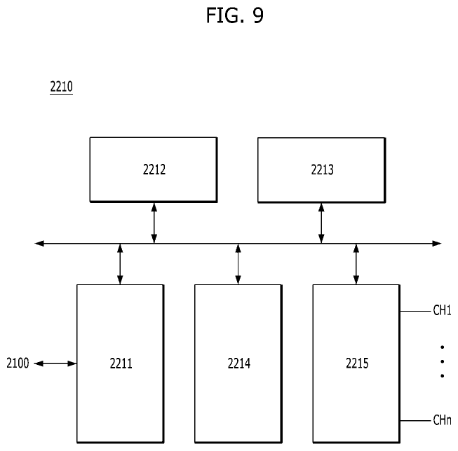

FIG. 9 illustrates the controller 2210 of FIG. 8. Referring to FIG. 9, the controller 2210 may include a host interface 2211, a control component 2212, a random access memory (RAM) 2213, an error correction code (ECC) component 2214, and a memory interface 2215.

The host interface 2211 may perform interfacing between the host apparatus 2100 and the SSD 2200 according to a protocol of the host apparatus 2100. For example, the host interface 2211 may communicate with the host apparatus 2100 through any of a secure digital protocol, a universal serial bus (USB) protocol, a multimedia card (MMC) protocol, an embedded MMC (eMMC) protocol, a personal computer memory card international association (PCMCIA) protocol, a parallel advanced technology attachment (PATA) protocol, a serial advanced technology attachment (SATA) protocol, a small computer system interface (SCSI) protocol, a serial attached SCSI (SAS) protocol, a peripheral component interconnection (PCI) protocol, a PCI Express (PCI-E) protocol, and a universal flash storage (UFS) protocol. The host interface 2211 may perform a disc emulation function that the host apparatus 2100 recognizes the SSD 2200 as a general-purpose data storage apparatus, for example, a hard disc drive HDD.

The control component 2212 may analyze and process the signal SGL input from the host apparatus 2100. The control component 2212 may control operations of internal functional blocks according to firmware and/or software for driving the SDD 2200. The RAM 2213 may be operated as a working memory for driving the firmware or software.

The ECC component 2214 may generate parity data for the data to be transferred to the nonvolatile memory devices 2231 to 223n. The parity data may be stored in the nonvolatile memory devices 2231 to 223n together with the data. The ECC component 2214 may detect errors in data read from the nonvolatile memory devices 2231 to 223n based on the parity data. When detected errors are within a correctable range, the ECC component 2214 may correct the detected errors.

The memory interface 2215 may provide a control signal such as a command and an address to the nonvolatile memory devices 2231 to 223n according to control of the control component 2212. The memory interface 2215 may exchange data with the nonvolatile memory devices 2231 to 223n according to control of the control component 2212. For example, the memory interface 2215 may provide data stored in the buffer memory device 2220 to the nonvolatile memory devices 2231 to 223n or provide data read from the nonvolatile memory devices 2231 to 223n to the buffer memory device 2220.

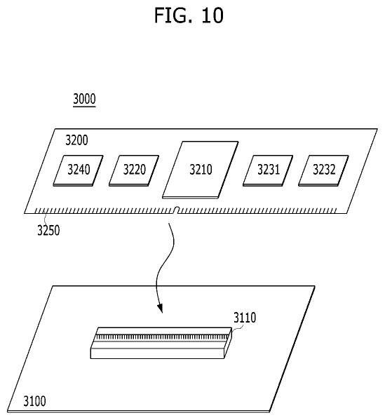

FIG. 10 illustrates a data processing system including a data storage apparatus in accordance with an embodiment. Referring to FIG. 10, a data processing system 3000 may include a host apparatus 3100 and a data storage apparatus 3200.

The host apparatus 3100 may be configured in a board form such as a printed circuit board (PCB). Although not shown in FIG. 10, the host apparatus 3100 may include internal functional blocks configured to perform functions of the host apparatus 3100.

The host apparatus 3100 may include a connection terminal 3110 such as a socket, a slot, or a connector. The data storage apparatus 3200 may be mounted on the connection terminal 3110.

The data storage apparatus 3200 may be configured in a board form such as a PCB. The data storage apparatus 3200 may refer to a memory module or a memory card. The data storage apparatus 3200 may include a controller 3210, a buffer memory device 3220, nonvolatile memory devices 3231 to 3232, a power management integrated circuit (PMIC) 3240, and a connection terminal 3250.

The controller 3210 may control overall operation of the data storage apparatus 3200. The controller 3210 may be configured the same as the controller 2210 illustrated in FIG. 9.

The buffer memory device 3220 may temporarily store data to be stored in the nonvolatile memory devices 3231 and 3232. The buffer memory device 3220 may temporarily store data read from the nonvolatile memory devices 3231 and 3232. The data temporarily stored in the buffer memory device 3220 may be transmitted to the host apparatus 3100 or the nonvolatile memory devices 3231 and 3232 according to control of the controller 3210.

The nonvolatile memory devices 3231 and 3232 may be used as a storage medium of the data storage apparatus 3200.

The PMIC 3240 may provide power input through the connection terminal 3250 to the inside of the data storage apparatus 3200. The PMIC 3240 may manage the power of the data storage apparatus 3200 according to control of the controller 3210.

The connection terminal 3250 may be coupled to the connection terminal 3110 of the host apparatus 3100. A signal such as a command, an address, and data and power may be transmitted between the host apparatus 3100 and the data storage apparatus 3200 through the connection terminal 3250. The connection terminal 3250 may be configured in any of various forms according to an interfacing method between the host apparatus 3100 and the data storage apparatus 3200. The connection terminal 3250 may be arranged in or one any side of the data storage apparatus 3200.

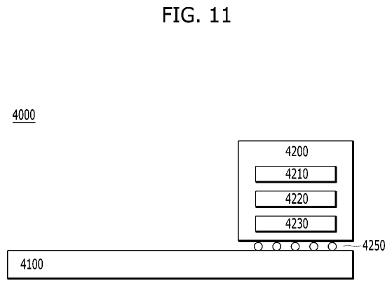

FIG. 11 illustrates a data processing system including a data storage apparatus in accordance with an embodiment. Referring to FIG. 11, a data processing system 4000 may include a host apparatus 4100 and a data storage apparatus 4200.

The host apparatus 4100 may be configured in a board form such as a PCB. Although not shown in FIG. 11, the host apparatus 4100 may include internal functional blocks configured to perform functions of the host apparatus 4100.

The data storage apparatus 4200 may be configured in a surface mounting packaging form. The data storage apparatus 4200 may be mounted on the host apparatus 4100 through a solder ball 4250. The data storage apparatus 4200 may include a controller 4210, a buffer memory device 4220, and a nonvolatile memory device 4230.

The controller 4210 may control overall operation of the data storage apparatus 4200. The controller 4210 may be configured to have the same configuration as the controller 2210 illustrated in FIG. 9.

The buffer memory device 4220 may temporarily store data to be stored in the nonvolatile memory device 4230. The buffer memory device 4220 may temporarily store data read from the nonvolatile memory device 4230. The data temporarily stored in the buffer memory device 4220 may be transmitted to the host apparatus 4100 or the nonvolatile memory device 4230 through control of the controller 4210.

The nonvolatile memory device 4230 may be used as a storage medium of the data storage apparatus 4200.

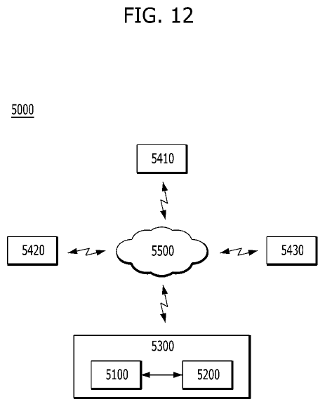

FIG. 12 illustrates a network system 5000 including a data storage apparatus in accordance with an embodiment. Referring to FIG. 12, the network system 5000 may include a server system 5300 and a plurality of client systems 5410 to 5430 which are coupled through a network 5500.

The server system 5300 may serve data in response to requests of the plurality of client systems 5410 to 5430. For example, the server system 5300 may store data provided from the plurality of client systems 5410 to 5430. In another example, the server system 5300 may provide data to the plurality of client systems 5410 to 5430.

The server system 5300 may include a host apparatus 5100 and a data storage apparatus 5200. The data storage apparatus 5200 may be configured of the storage device 10 of FIG. 1, the SSD 2200 of FIG. 8, the data storage apparatus 3200 of FIG. 10, or the data storage apparatus 4200 of FIG. 11.

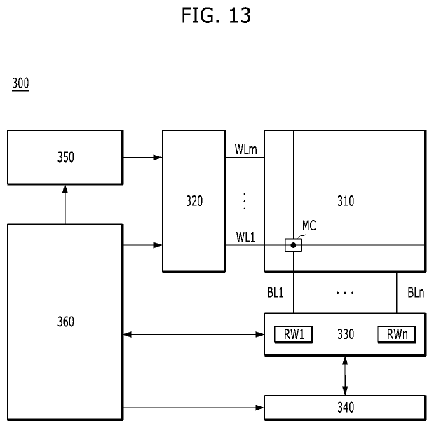

FIG. 13 illustrates a nonvolatile memory device included in a data storage apparatus in accordance with an embodiment. Referring to FIG. 13, a nonvolatile memory device 100 may include a memory cell array 110, a row decoder 120, a column decoder 140, a data read/write block 130, a voltage generator 150, and control logic 160.

The memory cell array 110 may include memory cells MC arranged in regions in which word lines WL1 to WLm and bit lines BL1 to BLn cross to each other.

The row decoder 120 may be coupled to the memory cell array 110 through the word lines WL1 to WLm. The row decoder 120 may operate through control of the control logic 160. The row decoder 120 may decode an address provided from an external apparatus (not shown). The row decoder 120 may select and drive the word lines WL1 to WLm based on a decoding result. For example, the row decoder 120 may provide a word line voltage provided from the voltage generator 150 to the word lines WL1 to WLm.

The data read/write block 130 may be coupled to the memory cell array 110 through the bit lines BL1 to BLn. The data read/write block 130 may include read/write circuits RW1 to RWn corresponding to the bit lines BL1 to BLn. The data read/write block 130 may operate according to control of the control logic 160. The data read/write block 130 may operate as a write driver or a sense amplifier according to an operation mode. For example, the data read/write block 130 may operate as the write driver configured to store data provided from an external apparatus in the memory cell array 110 in a write operation. In another example, the data read/write block 130 may operate as the sense amplifier configured to read data from the memory cell array 110 in a read operation.

The column decoder 140 may operate though control of the control logic 160. The column decoder 140 may decode an address provided from an external apparatus (not shown). The column decoder 140 may couple the read/write circuits RW1 to RWn of the data read/write block 130 corresponding to the bit lines BL1 to BLn and data input/output (I/O) lines (or data I/O buffers) based on a decoding result.

The voltage generator 150 may generate voltages used for an internal operation of the nonvolatile memory device 100. The voltages generated through the voltage generator 150 may be applied to the memory cells of the memory cell array 110. For example, a program voltage generated in a program operation may be applied to word lines of memory cells in which the program operation is to be performed. In another example, an erase voltage generated in an erase operation may be applied to well regions of memory cells in which the erase operation is to be performed. In another example, a read voltage generated in a read operation may be applied to word lines of memory cells in which the read operation is to be performed.

The control logic 160 may control overall operation of the nonvolatile memory device 100 based on a control signal provided from an external apparatus. For example, the control logic 160 may control an operation of the nonvolatile memory device 100 such as a read operation, a write operation, an erase operation of the nonvolatile memory device 100.

While various embodiments have been illustrated and described above, it will be understood by those skilled in the art that the disclosed embodiments are examples only, and that various modifications may be made to any such embodiment consistent with the teachings herein. Accordingly, the present invention is not limited by or to any of the disclosed embodiments. Rather, the present invention encompasses all variations that fall within the scope of the claims.

What is claimed is:

1. A storage device comprising:
a nonvolatile memory configured to store map data; and
a controller configured to read map data to be uploaded among the map data, to divide the map data to be uploaded into a plurality of map units, to sequentially encode the plurality of map units, and to transmit the encoded map units to a host,
wherein the controller encodes a next map unit while transmitting a previously encoded map unit to the host.

2. The storage device according to claim 1, further comprising:
a volatile memory,
is wherein the volatile memory includes a first buffer configured to read and store the map data to be uploaded from the nonvolatile memory, and a second buffer configured to store the encoded map units.

3. The storage device according to claim 2, wherein the controller divides the map data to be uploaded, which is stored in the first buffer, into the plurality of map units, sequentially reads and encodes the plurality of map units from the first buffer starting from a first map unit, and stores the encoded map units in the second buffer.

4. The storage device according to claim 2, further comprising: a data transmission circuit configured to read the encoded map units from the second buffer and transmit the read map units to the host according to control of the controller.

5. An operating method of a storage device including an operating method comprising:
reading map data to be uploaded among the map data from the nonvolatile memory;
dividing the map data to be uploaded into a plurality of map units; and
sequentially encoding the plurality of map units and transmitting the encoded map units to a host,
wherein the encoding and transmitting includes encoding a next map unit while transmitting a previously encoded map unit to the host.

6. The operating method according to claim 5, wherein the reading of the map data to be uploaded comprises: storing the map data to be uploaded in a map loading buffer.

7. The operating method according to claim 6, wherein the encoding and transmitting of the plurality of map units comprises:
reading and encoding the map units from the map loading buffer;
storing the encoded map units in a map uploading buffer; and
reading the encoded map units from the map uploading buffer and transmitting the read map units to the host.

8. The operating method according to claim 7, further comprising: determining whether encoding of a last map unit of the plurality of map units has been completed.

9. The operating method according to claim 8, further comprising, when the encoding of the last map unit has not been completed:
reading and encoding a subsequent map unit from the map loading buffer;
storing the encoded subsequent map unit in the map uploading buffer; and
reading the encoded subsequent map unit from the map uploading buffer and transmitting the encoded subsequent map unit to the host.

10. The operating method according to claim 9, wherein the reading of the encoded subsequent map unit from the map uploading buffer and the transmitting of the encoded subsequent map unit to the host is performed simultaneously with the reading and encoding of a map unit, which follows the encoded subsequent map unit, from the map loading buffer.

11. A controller comprising:
a first core configured to serve as an interface with a host;
a memory including a first buffer and a second buffer larger than the first buffer; and
a second core configured to read map data to be uploaded among map data stored in a nonvolatile memory and to store the read map data to be uploaded in the first buffer,
wherein the first core is further configured to divide the map data to be uploaded, which is stored in the first buffer, into a plurality of map units, sequentially encode the plurality of map units, store the encoded map units in the second buffer, and transmit the encoded map units from the second buffer to the host, and
wherein the first core encodes a next map unit while transmitting a previously encoded map unit to the host.

12. The controller according to claim 11, further comprising:
a data transmission circuit configured to read the encoded map units stored in the second buffer and transmit the read map units to the host according to control of the first core.
